(19) United States
(12) Patent Application Publication
(10) Pub. No.: US 2013/0246033 A1
(43) Pub. Date: Sep. 19, 2013

(54) PREDICTING PHENOTYPES OF A LIVING BEING IN REAL-TIME

(71) Applicants: David Earl Heckerman, Santa Monica, CA (US); Jennifer Listgarten, Santa Monica, CA (US); Carl M. Kadie, Bellevue, WA (US); Omer Weissbrod, Los Angeles, CA (US)

(72) Inventors: David Earl Heckerman, Santa Monica, CA (US); Jennifer Listgarten, Santa Monica, CA (US); Carl M. Kadie, Bellevue, WA (US); Omer Weissbrod, Los Angeles, CA (US)

(73) Assignee: MICROSOFT CORPORATION, Redmond, WA (US)

(21) Appl. No.: 13/419,439

(22) Filed: Mar. 14, 2012

(51) Int. Cl. G06G 7/60

(52) U.S. Cl. 703/11

(57) ABSTRACT

Described herein are technologies pertaining to predicting whether a living being, such as a human being, an animal, or a plant, has a phenotype or set of phenotypes in real-time or near real-time. A filter set of genetic markers are determined heuristically, by first univariately computing scores for respective genetic markers that are indicative of their predictive ability with respect to the phenotype or the set of phenotypes. Thereafter, during training, the filter set is initially selected and thereafter expanded based upon the scores, until predictive accuracy for the phenotype or set of phenotypes reaches a threshold or is optimized. The filter set, which includes a relatively small number of genetic markers, is subsequently employed for real-time or near-real time phenotype prediction.

### BACKGROUND

In the recent past, Genome Wide Association Studies (GWASs) have been undertaken in an attempt to identify correlations between genetics and disease. A GWAS is an examination of many common genetic variants across different individuals to ascertain if a particular variant is associated with a certain phenotype. A phenotype is a trait, such as height of an individual, weight of an individual, diseases that afflict an individual, etc. Typically, single nucleotide polymorphisms (SNPs) are investigated in GWASs to ascertain whether SNPs are associated with a phenotype or set of phenotypes.

Attempting to identify SNPs that correspond to certain phenotypes is a computationally expensive task. For example, a human body has approximately 50 trillion cells, and each cell has approximately 20,000 genes therein. A gene is a small portion of the Deoxyribonucleic acid (DNA) of an individual, where DNA is a double-stranded molecule composed of sugars and phosphate groups, and includes bases adenine, thiamine, cytosine, and guanine. Long molecules of DNA that include genes are organized into portions that are referred to as chromosomes. Humans have 46 chromosomes: two sets of 23, and an entire set of 23 chromosomes is referred to as a genome.

The human genome is composed of approximately three billion base pairs, and a variation at a single base pair is a SNP. During cell generation, when the genome is copied, a single base pair can be removed, added, or substituted. Single base pair substitutions create SNPs. There are approximately 10,000,000 SNPs in the human genome, which account for genetic differences between individuals. A subset of such SNPs account for differences in appearance, differences in how diseases are developed in individuals, differences in how individuals respond to certain environmental factors, such as pharmaceutical drugs, etc.

Phenotypes result from interaction between genes of individuals in their respective environments. As can be ascertained, due to the large number of SNPs, it is computationally expensive to ascertain which subset of the 10 million potential SNPs corresponds to a particular phenotype. Further, even after certain SNPs are identified as corresponding to a particular phenotype, a system that utilizes such known correlations in a meaningful way has been heretofore lacking.

### SUMMARY

The following is a brief summary of subject matter that is described in greater detail herein. This summary is not intended to be limiting as to the scope of the claims.

Described herein are various technologies pertaining to predicting whether a living being has a certain phenotype (or set of phenotypes) in real-time or near real-time based upon a relatively small number of genetic markers—a task that is different from GWASs. The genetic markers utilized to predict the certain phenotype or set of phenotypes are ascertained during a pre-processing stage, where genetic markers are univariately analyzed for their respective abilities to predict the phenotype or set of phenotypes. With more particularity, labeled training data is analyzed, wherein the training data comprises values for sets of genetic markers for respective living beings and labels indicating phenotypes of the living beings. The labels for the phenotypes can be discrete or continuous. Exemplary genetic markers that can be considered include SNPs, copy number variations (CNVs), and epigenetic markers, amongst others. For a particular phenotype or set of phenotypes, genetic markers are univariately analyzed and scores are computed for respective genetic markers, where a score that is computed for a genetic marker is indicative of an ability to predict the phenotype or set of phenotypes based solely upon the genetic marker. Accordingly, a plurality of scores can be computed for the respective plurality of genetic markers represented in the training data.

Subsequently, a set of genetic markers, which is composed of a thresholded number of genetic markers with highest scores assigned thereto, can be selected. During a testing/validation stage, accuracy of predicting the phenotype or set of phenotypes based upon the set of genetic markers is computed. In an exemplary embodiment, thereafter, the set of genetic markers can be expanded based upon the scores computed for the genetic markers. Accuracy of predicting the phenotype or set of phenotypes based upon the expanded set can subsequently be ascertained. When the accuracy for predicting the phenotype is 1) above a predefined threshold accuracy; 2) optimized; or 3) increases by less than a predefined threshold amount, the set of genetic markers that correspond to such accuracy can be saved as a filter set. In a first exemplary embodiment, a number of genetic markers in the filter set is less than 10,000. In a second exemplary embodiment, the number of genetic markers in the filter set is less than 5,000. In a third exemplary embodiment, the number of genetic markers in the filter set is less than 1,000.

Subsequent to the filter set being identified for the phenotype or set of phenotypes, whether a living being has the phenotype or set of phenotypes can be predicted in real-time or near real-time. A data packet for the living being comprises a plurality of values for a plurality of respective genetic markers. The filter set is applied to the data packet, such that values for the genetic markers in the filter set are extracted from the data packet. Accordingly, for instance, less than 10,000 values may be extracted from the data packet. A prediction as to whether the living being has the phenotype or set of phenotypes is then generated based upon the values extracted from the data packet. In an exemplary embodiment, a linear mixed model (LMM) can be employed in connection with predicting whether the living being has the phenotype or set of phenotypes. Accordingly, a similarity matrix can be populated with the values extracted from the data packet (as well as values for the genetic markers in the filter set for other living beings). An LMM algorithm can then be executed over the LMM, and the result of the execution of such algorithm over the LMM can be predictive as to whether the living being has the phenotype or set of phenotypes.

This real-time prediction of whether living beings have certain phenotypes can be employed in a variety of settings. In an example, an individual may be diagnosed with a certain ailment, and a variety of different types of pharmaceutical drugs may be prescribable to the individual to treat the ailment. A pharmacist can use the predictive mechanisms described herein in connection with selecting which of the pharmaceutical drugs to prescribe to the individual. For example, the pharmacist would not wish to prescribe a drug to the individual that may cause the individual to have some undesirable reaction.

Other aspects will be appreciated upon reading and understanding the attached figures and description.

### BRIEF DESCRIPTION OF THE DRAWINGS

FIG. 1 is a functional block diagram of an exemplary system that facilitates predicting whether a living being has a certain phenotype or set of phenotypes based upon a subset of genetic markers for the living being.

FIG. 2 is a functional block diagram of an exemplary system that facilitates univariately assigning scores to genetic markers, wherein a score assigned to a genetic marker is indicative of predictability of a phenotype based upon the genetic marker.

FIG. 3 is a functional block diagram of an exemplary system that facilitates ascertaining a filter set of genetic markers to utilize when predicting whether a living being has a certain phenotype or set of phenotypes.

FIG. 4 is a flow diagram that illustrates an exemplary methodology for outputting graphical data that is indicative of whether a living being is predicted to have a certain phenotype or set of phenotypes.

FIG. 5 is a flow diagram that illustrates an exemplary methodology for identifying a set of genetic markers to employ in connection with predicting whether living beings have a certain phenotype.

FIG. 6 is an exemplary computing system.

### DETAILED DESCRIPTION

Various technologies pertaining to predicting whether a living being has a phenotype or set of phenotypes in real-time or near real-time will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

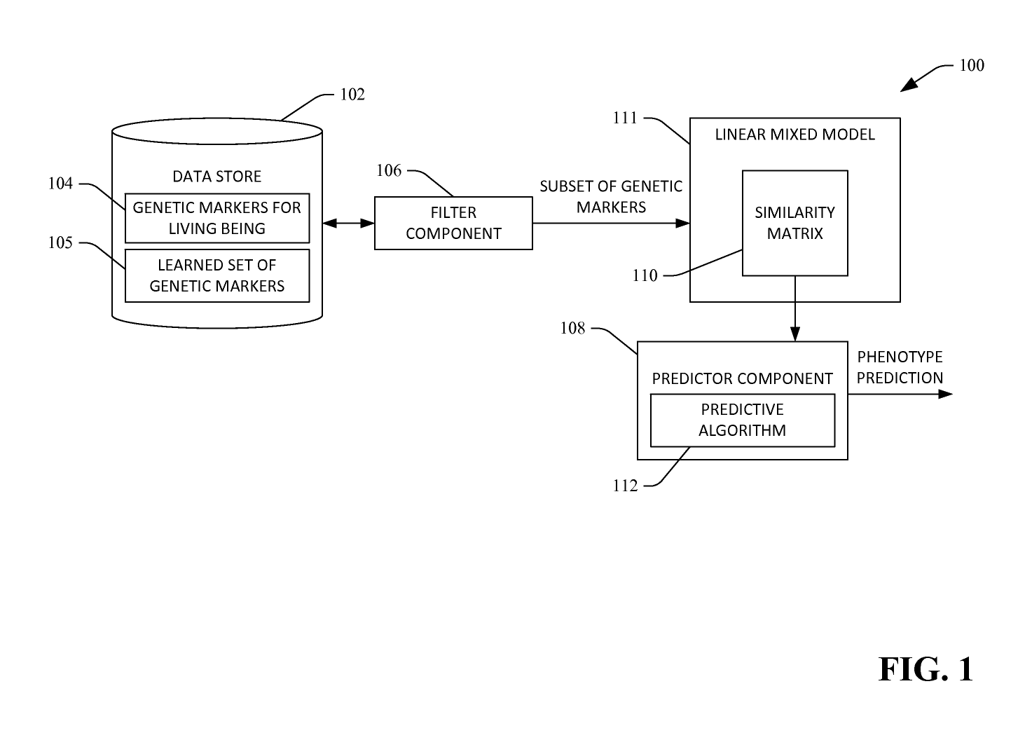

With reference now to FIG. 1, an exemplary system 100 that facilitates predicting whether a living being has a certain phenotype or set of phenotypes is illustrated. The phenotype that is desirably the subject of prediction can be discrete in nature (e.g. whether the living being is susceptible to a particular disease), or continuous (height, weight, hair color, etc.). A living being can be a human being, a domesticated animal (dog, cat, etc.), livestock (cow, goat, horse, etc.), exotic animal (lion, tiger, elephant, etc.), a plant (including a flower, a crop, etc.), an aquatic animal, a rodent, an insect, or any other suitable living being that includes genetic markers. A phenotype can be any suitable trait of a living being, wherein the trait is based at least partially on the genetic makeup of the living being. Therefore, exemplary phenotypes include but are not limited to whether a living being has a certain disease; whether the living being is susceptible to a certain disease; whether the living being will have a certain reaction to a particular pharmaceutical drug (or some other environmental condition); whether the living being will have an undesirable reaction upon consuming a pharmaceutical drug; whether the living being will have a desirable reaction upon consuming a pharmaceutical drug; whether a prescribed dosage of a pharmaceutical drug is appropriate for the living being; etc. Further, a phenotype that is desirably the subject of prediction can include a molecular phenotype.

The system 100 is particularly advantageously employed in situations where real-time or near real-time prediction of whether a living being has a certain phenotype or set of phenotypes is desired, such as for prescription of pharmaceutical drugs to a human being, when emergency medical services are desirably provided to a human being, etc. Real-time or near real-time prediction refers to predicting whether the living being has a phenotype or set of phenotypes in less than five minutes utilizing conventional computing devices, such as processors with clock speeds of greater than two Gigahertz and memory greater than four gigabytes. Predicting whether a living being has a certain phenotype or set of phenotypes in real-time with relatively high accuracy is realized through: 1) selection of a relatively small number of genetic markers of the living being to employ when predicting the phenotype or set of phenotypes; and 2) utilization of a linear mixed model (LMM) when performing the predicting. Selection of which of the genetic markers to utilize for the predicting and an exemplary algorithm to execute over a linear mixed model are set forth herein. Optionally, in act 1) mentioned above, other parameters can be selected when predicting the phenotype or set of phenotypes, wherein such other parameters can include non-genetic features, such as, but not limited to, environmental features (location of residence of the user, weather conditions experienced by the user, air quality at the residence of the user, and so forth).

Further, higher order interaction among features can be contemplated when predicting phenotypes. In an example, it can be learned that certain genetic markers (or non-genetic covariates), when considered in conjunction, are predictive of a phenotype or set of phenotypes, but when considered separately, are not predictive of the phenotype of set of phenotypes. A combination of genetic markers is referred to as a “higher order feature”. A higher order feature can be learned a priori, such that genetic markers in such feature are always considered in conjunction.

The system 100 comprises a data store 102, which can be any suitable computer-readable data storage device such as, but not limited to, a hard drive, a flash drive, computer-readable memory (e.g., RAM, ROM, EPROM, EEPROM, . . . ), etc. The data store 102 comprises a first data packet 104 that includes a plurality of values for a respective plurality of genetic markers for a living being. Additionally, the first data packet 104 can include non-genetic features that may be indicative of a phenotype or set of phenotypes of the living being. The first data packet 104 can be acquired through laboratory tests on a sample of the living being, such as saliva, blood, hair, skin, or the like. Conventional laboratories can generate a data packet for the living being that includes one million or more values for one million or more respective genetic markers for a nominal fee. Genetic markers that can be represented in the first data packet 104 include, but are not limited, to single nucleotide polymorphisms (SNPs), copy number variations (CNVs), and/or epigenetic markers.

The data store 102 further comprises a second data packet 105 that includes a learned filter set of genetic markers, non-genetic features, and/or higher order features. The learned filter set comprises identities of genetic markers learned in a pre-processing stage, which will be described below, as well as (optionally) the non-genetic features and/or higher-order features. In an exemplary embodiment, the number of genetic markers in the filter set can be less than 10,000. In another exemplary embodiment, the number of genetic markers in the filter set can be less than 5,000. In still yet another exemplary embodiment, the number of genetic markers in the filter set can be less than 1,000.

The system 100 additionally comprises a filter component 106 that accesses the data store 102 and selectively filters a subset of values from the values in the first data packet 104 that correspond to genetic markers identified in filter set included in the second data packet 105 (and/or non-genetic features included in the second data packet). In other words, the filter component 106 extracts values for genetic markers of the living being identified in the filter set, values for non-genetic features identified in the filter set, and/or values for higher order features identified in the filter set. Responsive to extracting the subset of values from the first data packet 104, the filter component 106 outputs such subset of values.

The system 100 further comprises a predictor component 108 that receives the subset of values output by the filter component 106 and computes a prediction as to whether the living being has the certain phenotype based at least in part upon the subset of values. As a number of values in the subset of values received by the predictor component 108 is relatively small in comparison to a number of potential genetic markers in the living being, the predictor component 108 can perform the prediction in real-time or near real-time.

In an exemplary embodiment, the filter component 106 can populate a similarity matrix 110 of a LMM 111 with the subset of values extracted from the first data packet 104. The similarity matrix 110 can also be populated with values for the genetic markers in the filter set for a plurality of other living beings. In an exemplary embodiment, the similarity matrix 110 can include values for genetic markers in the filter set for living beings that have the phenotype and/or set of phenotypes. Additionally, the similarity matrix can include values for genetic markers in the filter set for living beings that are similar to the living being of interest but do not have the phenotype or set of phenotypes. As LMMs and similarity matrices will be understood by one skilled in the art, additional explanation thereof is omitted for sake of brevity.

The predictor component 108 comprises a predictive algorithm 112 that executes over the LMM 111 that comprises the similarity matrix 110, and outputs a prediction as to whether the living being corresponding to the first data packet 104 has the phenotype or set of phenotypes based at least in part upon contents of the similarity matrix 110. In an exemplary embodiment, the predictive algorithm 112 can be an LMM algorithm.

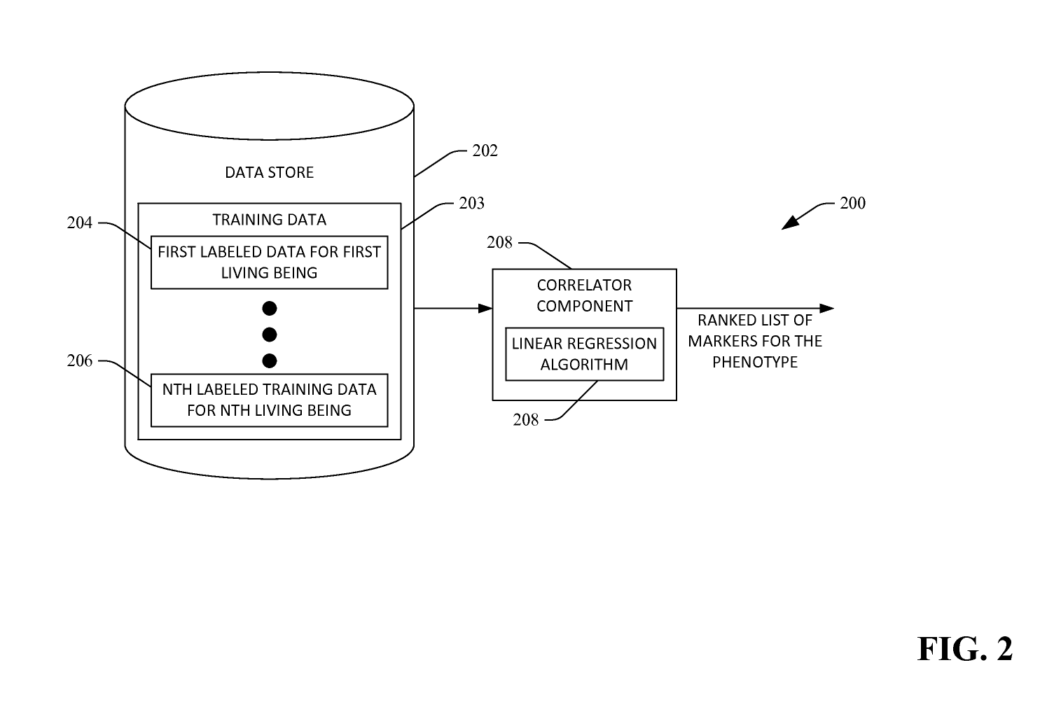

With reference now to FIG. 2, an exemplary system 200 that facilitates assigning scores to respective genetic markers univariately based upon their respective ability to predict a particular phenotype or set of phenotypes. Additionally, the exemplary system 200 facilitates assigning scores to respective non-genetic features and/or higher order features univariately based upon their respective ability to predict a particular phenotype or set of phenotypes. The system 200 comprises a data store 202 that includes training data 203. The training data 203 includes first labeled data for a first living being 204, . . . , through Nth labeled data for an Nth living being 206. The labeled data for the first living being 204 comprises values for respective genetic markers for the first living being as well as identities of phenotypes of the first living being. Optionally, the labeled data for the first living being 204 comprises values for respective non-genetic features for the first living being and/or values for respective higher order features for the first living being. Similarly, the Nth labeled data for and Nth living being 206 comprises similar values for the Nth living being as well as identities of phenotypes of the Nth living being.

The system 200 further comprises a correlator component 208 that analyzes the labeled training data 203 in the data store 202 and outputs a ranked list of markers for a specified phenotype or set of phenotypes, wherein the ranked list of markers can include genetic markers, non-genetic features, and/or higher order features. In an exemplary embodiment, the ranked list of markers includes only genetic markers. More specifically, the correlator component computes scores for the markers represented in the training data 203, wherein a score assigned to a marker is indicative of an ability to predict the phenotype using solely such marker. In an exemplary embodiment, the correlator component 208 can comprise a linear regression algorithm 210 that performs a univariate linear regression procedure over a marker to assign a score to the marker based upon its ability to predict a specified phenotype. The correlator component 208, in an example, can perform such univariate linear analysis over each marker represented in the training data 203. In other embodiments, the correlator component 208 can perform such univariate linear analysis over an identified subset of markers represented in the training data 203, wherein the subset has been previously recognized as being correlated with the phenotype or set of phenotypes of interest. Cross validation can be employed to validate scores computed for markers. If the correlator component 208 assigns a relatively high score to a marker with respect to a phenotype or a set of phenotypes, then it can be inferred that the marker is likely either to be indirectly associated with the phenotype (e.g. by way of population structure) or to have an effect on the phenotype (directly or by tagging). The correlator component 208 may then order the markers by their respective linear regression values, and can output a ranked list of markers for the phenotype or set of phenotypes of interest.

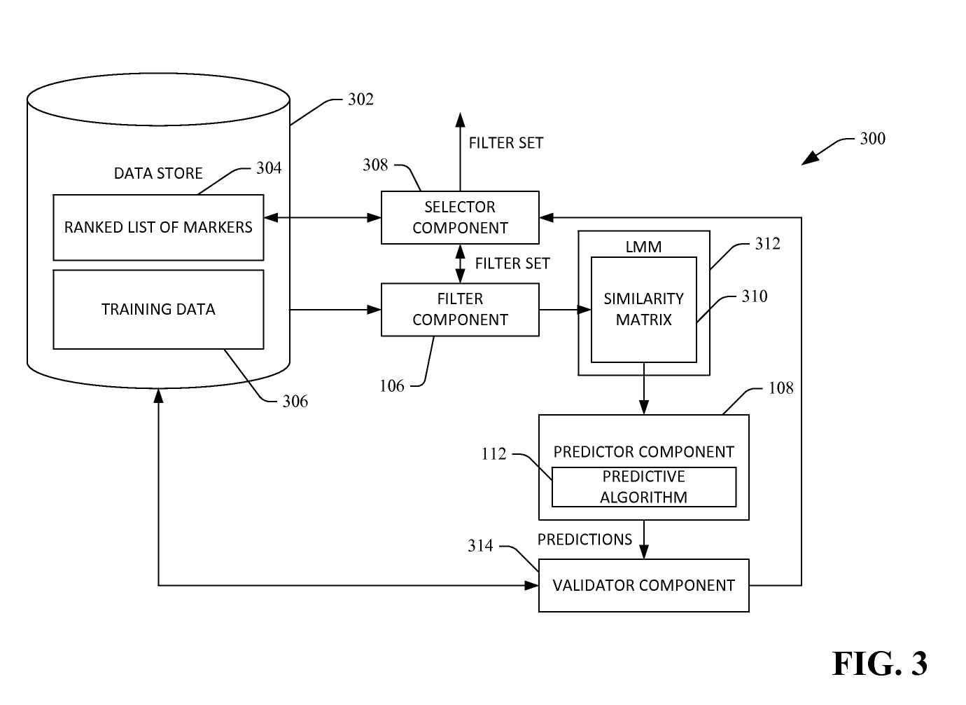

Turning now to FIG. 3, an exemplary system 300 that facilitates determining a filter set of markers to utilize when predicting for a phenotype or set of phenotypes in-real time is illustrated. The system 300 comprises a data store 302 that includes a ranked list of markers 304 as output, for example, by the correlator component 208. The data store 302 further comprises training data 306 (which can be, include, or be exclusive of the training data 203), wherein the training data includes, for a plurality of living beings, values for their respective markers and labels of phenotypes of the respective living beings.

The system 300 comprises a selector component 308 that selects, from the ranked list of markers 304, a filter set, wherein the filter set includes a threshold number of the most highly ranked markers in the ranked list of markers 304. The system 300 further comprises the filter component 106, which receives the filter set from the selector component 308 and extracts values for markers in the filter set from the training data 306. The filter component 106 then populates a similarity matrix 310 of a linear mixed model 312 with the extracted values. The predictor component 108 executes the predictive algorithm 112 over the linear mixed model 312 to output a prediction as to whether a test living being from the training data 306 has the phenotype of interest. The predictor component 108 can output predictions for several test living beings in the training data 306, and a validator component 314 can validate predictions output by the predictor component 108, for instance, through cross validation. Accordingly, the validator component 314, for the filter set selected by the selector component 308, can output a value that is indicative of the predictive accuracy of the predictor component 108 for the phenotype or set of phenotypes of interest when the similarity matrix 310 is populated with values for genetic markers in the filter set.

In an exemplary embodiment, the selector component 308 can compare the value output by the validator component 314 with a predefined threshold value to ascertain whether the predictor component 108 is sufficiently accurate when the filter set is employed to populate the similarity matrix 310. If the value output by the validator component 314 is at or above the predefined threshold value, then the selector component 308 can output the filter set for employment in predicting whether a living being has the phenotype or set of phenotypes in real-time. If the value output by the validator component 314 is below the predefined threshold value, then the selector component 308 can expand the filter set, adding one or more markers to the previous filter set according to their respective positions in the ranked list of markers 304 (e.g., a set of next most highly ranked markers are added to the filter set). The selector component 308 provides the updated filter set to the filter component 106, and the aforementioned process can iterate until a value output by the validator component 314 is at or above the predefined threshold value. Such an approach can be advantageously employed when a baseline predictive accuracy is desired.

In another exemplary embodiment, subsequent to the validator component 314 outputting a value that is indicative of predictive accuracy of the predictor component 108 when the similarity matrix is populated with values for genetic markers in the filter set, the selector component can expand the filter set as described above (regardless of the initial value output by the validator component 314). The filter component 106 can populate the similarity matrix 312 with values for genetic markers in the updated filter set, and the predictor component 108 can output predictions as to whether test living beings have the phenotype or set of phenotypes based at least in part upon the similarity matrix. The validator component 314 can thereafter, through cross validation, compute a value that is indicative of predictive accuracy of the predictor component 108 when the similarity matrix 310 is populated with values for genetic markers in the updated filter set. The selector component 308 can receive this value and can compare the value with a previous value or previous values output by the validator component 314 with respect to previously employed filter sets. If there is an improvement (e.g., about a threshold), then the filter set can be further expanded, and the process iterates until the predictive accuracy is optimized. In experimentation, it has been found that, at least for some phenotypes, considering more genetic markers when predicting phenotypes causes predictive accuracy to decline when compared to when fewer genetic markers are considered when predicting for the phenotype or set of phenotypes. Therefore, the selector component 308 can select the filter set that causes the predictive accuracy of the predictor component 108 to be optimized when predicting for the phenotype.

In another embodiment, the process can be iterated until predictive accuracy between filter sets is relatively flat (e.g., predictive accuracy does not improve between filter sets). For instance, expanding a filter set may have a statistically negligible effect on predictive accuracy of the predictor component 108 when predicting for the phenotype or set of phenotypes. Thus, the predictive accuracy for the phenotype or set of phenotypes may be relatively flat after a certain number of genetic markers are included in the filter set. In such a case, the selector component 308 can output a filter set that optimizes a tradeoff between performance and accuracy.

Referring back to FIG. 1, an exemplary instantiation of the predictive algorithm 112 that can be employed by the predictor component 108 is described. In this example, the predictive algorithm 112 is a LMM algorithm. Further, the algorithm is explained in connection with performing a GWAS in Lippert, et al, “Fast Linear Mixed Models for Genome-Wide Association Studies”, Nat. Methods, Sep. 4, 2011, Pages 1-5, the entirety of which is incorporated herein by reference. Adaption of the algorithm for utilization when predicting a phenotype will be readily contemplated by one skilled in the art.

The LMM log likelihood of the phenotype data, y (dimension n×1), given fixed effects X (dimension n×d), which include, for instance, the SNP to be tested, the covariates and the column of ones corresponding to the bias (offset), can be written as follows:

LL(δ, σₑ², σ_{g}², β)=log N(y|Xβ; σ_{g}²K+σₑ²I), (1)

where N(r|m; Σ) denotes a normal distribution in variable r with mean m and covariance matrix Σ; K (dimension n×n) is the genetic similarity matrix 110; I is the identity matrix; σₑ² (scalar) is the magnitude of the residual variance; σ_{g}² (scalar) is the magnitude of the genetic variance; and β (dimension d×1) are the fixed-effect weights.

To efficiently estimate the parameters β, σ_{g}² and σₑ², and the log likelihood at those values, equation (1) can be factored. In particular, δ can be σₑ²/σ_{g}² and USU^{T} can be the spectral decomposition of K (where U^{T} denotes the transpose of U), so that equation (1) becomes as follows:

$$LL ( δ , {σ}_{g}^{2} , β ) = - \frac{1}{2} ( n log ( 2 {πσ}_{g}^{2} ) + log ( \vert U ( S + δ I ) {U}^{T} \vert ) + \frac{1}{{σ}_{g}^{2}} {( y - X β )}^{T} {( U ( S + δ I ) {U}^{T} )}^{- 1} ( y - X β ) ) , \qquad ( 2 )$$

where |K| denotes the determinant of matrix K. The determinant of the genetic similarity matrix, |U(S+δI)U^{T}|, can be written as |S+δI|. The inverse of the genetic similarity matrix can be rewritten as U(S+δI)⁻¹U^{T}. Thus, after additionally moving out U from the covariance term so that it now acts as a rotation matrix on the inputs (X) and targets (y), the following can be obtained:

$$LL ( δ , {σ}_{g}^{2} , β ) = - \frac{1}{2} ( n log ( 2 {πσ}_{g}^{2} ) + log ( S + δ I ) + \frac{1}{{σ}_{g}^{2}} {( ( {U}^{T} y ) - ( {U}^{T} X ) β )}^{T} {( S + δ I )}^{- 1} ( ( {U}^{T} y ) - ( {U}^{T} X ) β ) ) . \qquad ( 3 )$$

As the covariance matrix of the normal distribution is now a diagonal matrix S+δI, the log likelihood can be rewritten as the sum over n terms, yielding the following:

$$LL ( δ , {σ}_{g}^{2} , β ) = - \frac{1}{2} ( n log ( 2 {πσ}_{g}^{2} ) + {\sum }_{i = 1}^{n} log ( {[ S ]}_{ii} + δ ) + \frac{1}{{σ}_{g}^{2}} {\sum }_{i = 1}^{n} \frac{{( {[ {U}^{T} y ]}_{i} - {[ {U}^{T} X ]}_{i :} β )}^{2}}{{[ S ]}_{ii} + δ} ) , \qquad ( 4 )$$

where [U^{T}X]ᵢ: denotes the ith row of X. It can be noted that this expression is equal to the product of n univariate normal distributions on the rotated data, yielding the following linear regression equation:

LL(δ, σ_{g}², β)=log Πᵢ₌₁ⁿN([U^{T}y]ᵢ|[U^{T}X]_{i:}β; σ_{g}²([S]ᵢᵢ)+δ) (5)

To determine the values of δ, σ_{g}², and β that maximize the log likelihood, equation (5) is first differentiated with respect to β, set to zero, and analytically solved for the maximum likelihood (ML) value of β(δ). This expression is then substituted in equation (5), the resulting expression is then differentiated with respect to σ_{g}², set to zero, and solved analytically for the ML value of σ_{g}²(δ). Subsequently, the ML values of a σ_{g}² (δ) and β(δ) can be plugged into equation (5) so that it is a function only of δ. Finally, this function of δ can be optimized using a one-dimensional numerical optimizer based on any suitable method.

It can be noted that, given δ and the spectral decomposition of K, each evaluation of the likelihood has a run time that is linear in n. Consequently, when testing s SNPs, the time complexity is O(n³) for finding all eigenvalues (S) and eigenvectors (U) of K, O(n²s) for rotating the phenotype vector y, and all of the SNP and covariate data (that is, computing U^{T}y and U^{T}X), and O(Cns) for performing C evaluations of the log likelihood during the one-dimensional optimization over δ. Therefore, the total time complexity of such algorithm, given K, is O(n³+n²s+Cns). By keeping δ fixed to its value from the null model, this complexity reduces to O(n³+n²s+Cn). The size of both K and U is O(n²), which dominates the space complexity, as each SNP can be processed independently so that there is no need to load all SNP data into memory at once. In most applications, the number of fixed effects per test, d, is a single-digit integer and is omitted in these expressions because its contribution is negligible.

Next the case where K is of low rank is considered; that is, k, the rank of K, is less than n, the number of individuals. This case will occur when the RRM is used and the number of (linearly independent) SNPs used to estimate it, s_{c}=k, is smaller than n. K can be of low rank for other reasons: for example, by forcing some eigenvalues to zero.

In the complete spectral decomposition of K given by USU^{T}, S can be an n×n diagonal matrix containing the k nonzero eigenvalues on the top left of the diagonal, followed by n−k zeros on the bottom right. In addition, the n×n orthonormal matrix U can be written as [U₁, U₂], where U₁ (of dimension n×k) contains the eigenvectors corresponding to nonzero eigenvalues, and U₂ (of dimension n×n−k)) contains the eigenvectors corresponding to zero eigenvalues. Thus, K is given by USU^{T}=U₁S₁U₁^{T}+U₂ S₂U₂^{T}. Furthermore, as S₂ is [0], K becomes U₁S₁U₁^{T}, the k-spectral decomposition of K, so-called because it contains only k eigenvectors and arises from taking the spectral decomposition of a matrix of rank k. The expression K+δI appearing in the LMM likelihood, however, is always of full rank (because δ>0):

$$K + δ I = U ( S + δ I ) {U}^{T} = U [ \begin{matrix}{S}_{1} + δ I & 0 \\ 0 & δ I\end{matrix} ] {U}^{T} . \qquad ( 6 )$$

Therefore, it is not possible to ignore U₂ as it enters the expression for the log likelihood. Furthermore, directly computing the complete spectral decomposition does not exploit the low rank of K. Consequently, an algebraic trick involving the identity U₂U₂^{T}=I−U₁U₁^{T} can be used to rewrite the likelihood in terms not involving U₂. As a result, only the time and space complexity of computing U₁ rather than U is incurred.

Given the k-spectral decomposition of K, the maximum likelihood of the model can be evaluated with time complexity O(nsk) for the required rotations and O(C(n+k)s) for the C evaluations of the log likelihood during the one-dimensional optimizations over δ. By keeping δ fixed to its value from the null model, O(C(n+k)s) is reduced to O(C(n+k)). In general, the k-spectral decomposition can be computed by first constructing the genetic similarity matrix from k SNPs at a time complexity of O(n²s_{c}) and space complexity of O(n²), and then finding its first k eigenvalues and eigenvectors at a time complexity of O(n²k). When the RRM is used, however, the k-spectral decomposition can be performed more efficiently by circumventing the construction of K because the singular vectors of the data matrix are the same as the eigenvectors of the RRM constructed from those data. In particular, the k-spectral decomposition of K can be obtained from the singular value decomposition of the n×s_{c} SNP matrix directly, which is an O(ns_{c}k) operation. Therefore, the total time complexity of the predictive algorithm 112 (low rank) using δ from the null model is O(ns_{c}k+nsk+C(n+k)). If it is assumed that SNPs to be tested are loaded into memory in small blocks, the total space complexity is O(ns_{c}). Moreover, it can be noted that rotations are parallelizable using the predictive algorithm 112. Accordingly, the run time of an LMM analysis is based mostly upon the spectral decomposition.

When the phenotype is binary, the likelihood of the phenotype for a given individual can be inferred by scaling the difference between the LL for the data with that individual's phenotype set to 1 and the LL for the data with that individual's phenotype set to 0. When the phenotype is continuous, its posterior distribution for an individual can be computed via a Gaussian Process. Namely, the phenotype for an individual with genotype X_{*} and covariates vector C, (which includes a bias term) follows a normal distribution whose mean and variance are given by C_{*}β+σₕ²K(X_{*}, X)[σ_{g}²K(X, X)+σₑ²I]⁻¹y and σ_{g}²K(X_{*}, X_{*})−σ_{g}²K(X_{*}, X)[σ_{g}²K(X, X)+σₑ²I]⁻¹σ_{g}²K(X, X_{*})+σₑ² respectively, where β is the covariate coefficients vector, X is the genotype matrix of individuals in the training set, y is the phenotypes of individuals in the training set, K is the kernel matrix and σ_{g}², σₑ² are the genetic and residual variances, respectively.

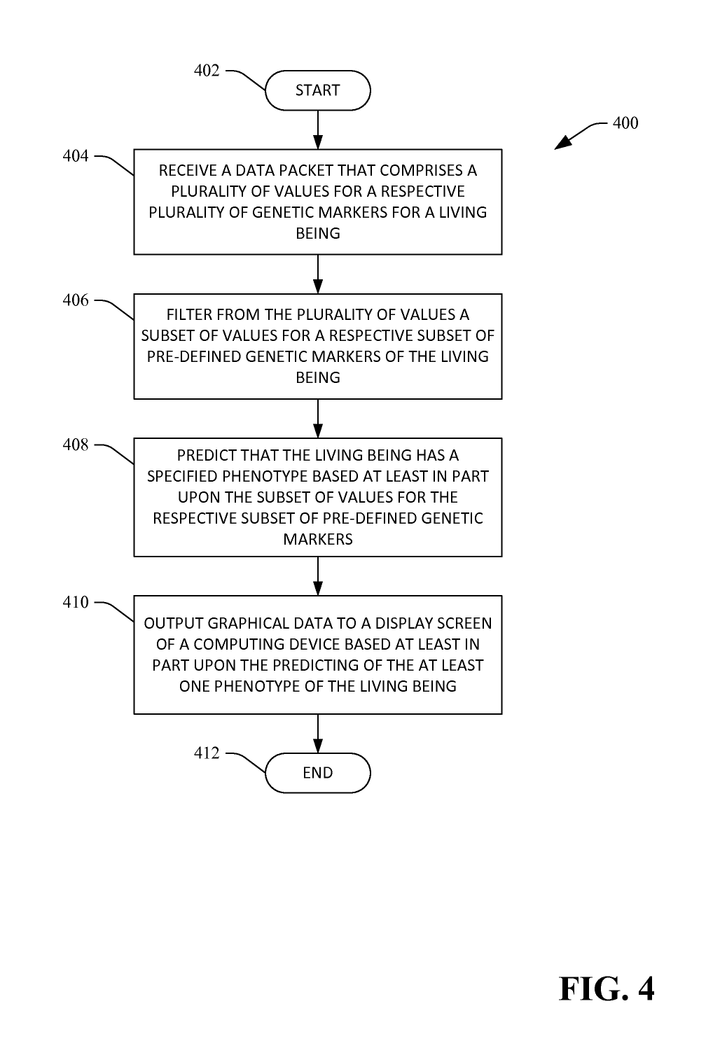

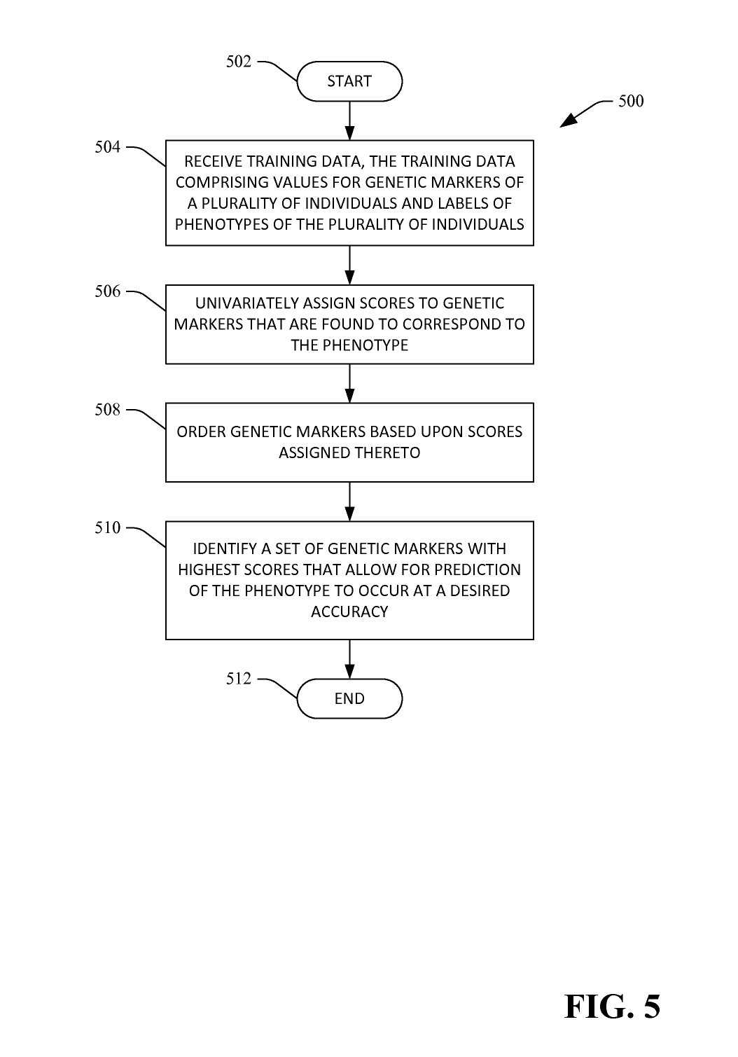

With reference now to FIGS. 4-5, various exemplary methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be any suitable computer-readable storage device, such as memory, hard drive, CD, DVD, flash drive, or the like. As used herein, the term “computer-readable medium” is not intended to encompass a propagated signal.

Referring now to FIG. 4, an exemplary methodology 400 that facilitates predicting whether a living being has a certain phenotype or set of phenotypes is illustrated. The methodology 400 starts at 402, and at 404 a data packet is received that comprises a plurality of values for a respective plurality of genetic markers for a living being. The plurality of genetic markers include at least one of SNPs, CNVs, or epigenetic markers.

At 406, a subset of values from the plurality of values for a respective subset of predefined genetic markers of the living being are filtered from the plurality of values. The identities of the genetic markers in the subset of genetic markers are learned in a pre-processing stage (described in with respect to FIGS. 2 and 3). In an example, a number of values in the subset of values is less than a number of values in the data packet. For instance, the number of values in the subset of values may be less than 10,000 less than 5,000, less than 1,000, or less than 500.

At 408, at least one phenotype is predicted for the living being, wherein the at least one phenotype is predicted based at least in part upon the subset of values for the respective subset of predefined genetic markers.

At 410, graphical data is output to a display screen of a computing device based at least in part upon the at least one phenotype of the living being predicted. The methodology 400 completes at 412.

Referring now to FIG. 5, an exemplary methodology 500 that facilitates identifying a set of genetic markers to employ as a filter set when predicting for a certain phenotype or set of phenotypes is illustrated. The methodology 500 starts at 502, and at 504 training data is received, wherein the training data comprises values for genetic markers of a plurality of individuals and labels of phenotypes of the plurality of individuals.

At 506, scores are assigned univariately to respective genetic markers, wherein the scores are indicative of their predictive ability with respect to the phenotype or set of phenotypes. For example, genetic markers that are significantly associated with the phenotype can be selected, and scores can be assigned to genetic markers by way of univariate linear regression.

At 508, genetic markers are ordered based upon the respective scores that are assigned thereto, and at 510 a set of genetic markers are identified as a filter set, wherein the filter set, when employed for phenotype prediction, is associated with a desired accuracy or an optimized accuracy. The genetic markers in the filter set are a subset of genetic markers with highest scores assigned thereto (based upon the scores assigned using univariate linear regression). The methodology 500 completes at 512.

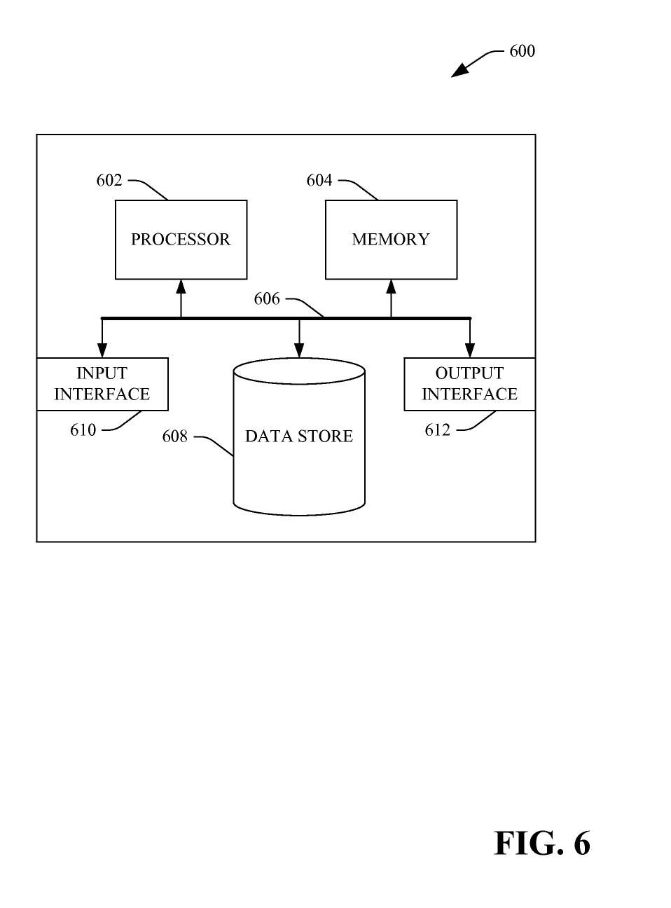

Now referring to FIG. 6, a high-level illustration of an exemplary computing device 600 that can be used in accordance with the systems and methodologies disclosed herein is illustrated. For instance, the computing device 600 may be used in a system that supports predicting whether a living being has a phenotype or a set of phenotypes. In another example, at least a portion of the computing device 600 may be used in a system that supports ascertaining which genetic markers to include in a filter set to employ for phenotype prediction/inference. The computing device 600 includes at least one processor 602 that executes instructions that are stored in a memory 604. The memory 604 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 602 may access the memory 604 by way of a system bus 606. In addition to storing executable instructions, the memory 604 may also store a filter set of genetic markers, identities of genetic markers, values for the respective genetic markers for a living being or set of living beings, etc.

The computing device 600 additionally includes a data store 608 that is accessible by the processor 602 by way of the system bus 606. The data store may be or include any suitable computer-readable storage, including a hard disk, memory, etc. The data store 608 may include executable instructions, training data, genetic markers, etc. The computing device 600 also includes an input interface 610 that allows external devices to communicate with the computing device 600. For instance, the input interface 610 may be used to receive instructions from an external computer device, a user, etc. The computing device 600 also includes an output interface 612 that interfaces the computing device 600 with one or more external devices. For example, the computing device 600 may display text, images, etc. by way of the output interface 612.

Additionally, while illustrated as a single system, it is to be understood that the computing device 600 may be a distributed system. Thus, for instance, several devices may be in communication by way of a network connection and may collectively perform tasks described as being performed by the computing device 600.

It is noted that several examples have been provided for purposes of explanation. These examples are not to be construed as limiting the hereto-appended claims. Additionally, it may be recognized that the examples provided herein may be permutated while still falling under the scope of the claims.

1. A method executed by a processor, the method comprising:
receiving a data packet that comprises a plurality of values that correspond to a respective plurality of genetic markers for a living being, the plurality of genetic markers comprising at least one of single nucleotide polymorphisms, copy number variations, or epigenetic markers;
filtering from the plurality of values a subset of values for a respective subset of pre-defined genetic markers of the living being, a number of values in the subset of values being less than a number of values in the data packet, and wherein identities of genetic markers in the subset of genetic markers are learned in a pre-processing stage to optimize phenotype prediction;
predicting at least one phenotype of the living being based at least in part upon the subset of values for the respective subset of pre-defined genetic markers; and
outputting graphical data to a display screen of a computing device based at least in part upon the predicting of the at least one phenotype of the living being.

2. The method of claim 1, wherein predicting the at least one phenotype of the living being is further based at least in part upon values of non-genetic features of the living being.

3. The method of claim 1, wherein the living being is a human being.

4. The method of claim 1, wherein the living being is a domesticated animal.

5. The method of claim 1, wherein the living being is a plant.

6. The method of claim 1, wherein predicting the at least one phenotype of the living being comprises executing a linear mixed model algorithm over at least the subset of values.

7. The method of claim 1, wherein the number of values in the subset of values is less than five percent of the number of values in the plurality of values.

8. The method of claim 1, wherein the number of values in the subset of values is less than ten thousand values.

9. The method of claim 1, wherein the number of values in the subset of values is less than five thousand values.

10. The method of claim 1, wherein the number of values in the subset of values is less than one thousand values.

11. The method of claim 1, wherein the at least one phenotype pertains to at least one of:
whether the living being will have an undesirable reaction upon consuming a pharmaceutical drug;
whether the living being will have a desirable reaction upon consuming a pharmaceutical drug;
whether the living being will get a particular disease; or
whether a prescribed dosage of a pharmaceutical drug is appropriate for the living being.

12. A system that facilitates predicting that a living being has a specified phenotype, the system comprising:
a processor; and
a memory in operable communication with the processor, the memory comprising a plurality of components that are executed by the processor, the plurality of components comprising:
a filter component that receives:
a plurality of values for a respective plurality of genetic markers for a living being; and
identities of genetic markers in a learned set of genetic markers, the genetic markers in the learned set of genetic markers having been learned in a training phase to optimize prediction for the specified phenotype;
wherein the filter component outputs a subset of values from the plurality of values, the subset of values being for genetic markers in the learned set of genetic markers, and
a predictor component that receives the subset of values and outputs a prediction as to whether the living being has the specified phenotype based at least in part upon the subset of values.

13. The system of claim 12, wherein the filter component populates a similarity matrix with the subset of values, and wherein the predictor component executes a linear mixed model algorithm over the similarity matrix to output the prediction.

14. The system of claim 12, wherein a first number of values in the subset of values is less than a second number of values in the plurality of values.

15. The system of claim 12, wherein the first number of values is less than ten thousand.

16. The system of claim 12, wherein the first number of values is less than five thousand.

17. The system of claim 12, wherein the genetic markers are single nucleotide polymorphisms.

18. The system of claim 12, wherein the living being is a human being or a domesticated animal.

19. The system of claim 12 comprised by a mobile computing device.

20. A computer-readable medium comprising instructions that, when executed by a processor, cause the processor to perform acts comprising:
receiving identities of genetic markers in a learned set of genetic markers, the genetic markers in the learned set of genetic markers learned to optimize predictive accuracy for a specified phenotype in human beings;
receiving, for a human being, values for respective genetic markers of the human being;
extracting a subset of values from the values for the respective genetic markers for the human being, the subset of values being for the genetic markers in the learned set of genetic markers, and a number of values in the subset of values being less than ten thousand;
populating a similarity matrix with the subset of values; and
executing a linear mixed model algorithm over the similarity matrix to output data that is indicative of whether the human being has the specified phenotype.
